(19) United States
(12) Patent Application Publication
(10) Pub. No.: US 2016/0010688 A1
(43) Pub. Date: Jan. 14, 2016

(54) LOW FRICTION MULTI STAGE THRUST BEARING

(71) Applicant: Schaeffler Technologies AG & Co. KG, Herzogenaurach (DE)

(72) Inventor: John Tate, Cornelius, NC (US)

(73) Assignee: Schaeffler Technologies AG & Co. KG, Herzogenaurach (DE)

(21) Appl. No.: 14/735,433

(22) Filed: Jun. 10, 2015

Related U.S. Application Data
(60) Provisional application No. 62/022,943, filed on Jul. 10, 2014.

(51) Int. Cl. F16C 33/40; F16C 33/48; F16C 19/49; F16C 19/10; F16C 19/30

(52) U.S. Cl. CPC F16C 33/40; F16C 19/10; F16C 19/305; F16C 19/49; F16C 33/48

(57) ABSTRACT

A thrust bearing having a circular cage with rolling elements disposed in at least some of pockets formed in the cage, upper and lower raceways having inward-facing surfaces disposed adjacent to the cage so that a first plurality of rolling elements is in rolling contact with the upper and lower raceways when the thrust bearing is in a first load condition and a second plurality of rolling elements is in rolling contact with the upper and lower raceways when the thrust bearing is in a second load condition.

### INCORPORATION BY REFERENCE

The following documents are incorporated herein by reference as if fully set forth: U.S. Provisional Patent Application No. 62/022,943, filed Jul. 10, 2014.

### FIELD OF INVENTION

The present invention relates to a bearing arrangement for thrust loads.

### BACKGROUND

Thrust bearings are known to support axial loads. Typical thrust bearings include spherical or cylindrical rolling elements arranged in a cage between two raceways. Generally, spherical rolling elements provide low friction and are suitable for low load conditions while cylindrical rolling elements tend to have greater energy loss and wear due to sliding but provide higher load carrying capacity.

Accordingly, a need exists for a thrust bearing that provides low friction and high load carrying capacity.

### SUMMARY

A thrust bearing providing enhanced friction characteristics and load carrying capacity is provided. In one embodiment, a thrust bearing is provided that comprises a circular cage having an upper cage surface and a lower cage surface with a thickness therebetween, and pockets formed through the thickness. Rolling elements are disposed in at least some of the pockets, with the rolling elements having a diameter greater than the thickness of the cage. Upper and lower raceways having inner and outer diameters and an intermediate portion between the inner and outer diameters formed with an inward-facing surface and an outward-facing surface are disposed on either side of the cage. The inner-facing surface of the upper raceway is disposed adjacent to the upper cage surface and the inner-facing surface of the lower raceway is disposed adjacent to the lower cage surface. In this configuration, a first plurality of rolling elements is in rolling contact with the upper and lower raceways when the thrust bearing is in a first load condition and a second plurality of rolling elements is in rolling contact with the upper and lower raceways when the thrust bearing is in a second load condition.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting in scope, for the invention may admit to other equally effective embodiments.

FIG. 1 is a perspective view of a thrust bearing in accordance with embodiments of the present invention.

FIG. 2 is a top plan view of the thrust bearing of FIG. 1 with the upper raceway removed.

FIG. 3 is an enlarged section of the illustration of FIG. 2.

FIG. 4 is side sectional view of an embodiment of the thrust bearing of FIG. 3 taken along line IV-IV in a first load condition.

FIG. 5 is a side sectional view of an embodiment of the thrust bearing of FIG. 3 taken along line IV-IV in a second load condition.

FIG. 6 is a perspective view of a thrust bearing in accordance with embodiments of the present invention.

FIG. 7 is a top plan view of the thrust bearing of FIG. 6 with the upper raceway removed.

FIG. 8 is an enlarged section of the illustration of FIG. 7

FIG. 9 is a side sectional view of an embodiment of the thrust bearing of FIG. 7 taken along line IX-IX in a first load condition.

FIG. 10 is side sectional view of an embodiment of the thrust bearing of FIG. 7 taken along line IX-IX in a second load condition.

FIG. 11 is a perspective view of a thrust bearing in accordance with embodiments of the present invention.

FIG. 12 is a plan view of the thrust bearing of FIG. 11 with the upper raceway removed.

FIG. 13 is an enlarged section of the illustration of FIG. 12.

FIG. 14 is a side sectional view of an embodiment of the thrust bearing of FIG. 13 taken along line XI-XI in a first load condition.

FIG. 15 is a side sectional view of an embodiment of the thrust bearing of FIG. 13 taken along line XI-XI in a second load condition.

### DETAILED DESCRIPTION

Certain terminology is used in the following description for convenience only and is not limiting. The words “upper” and “lower” designate directions in the drawings to which reference is made. The words “inner-facing” and “outer-facing” refer to directions toward and away from the center of the part being referenced. “Axially” refers to a direction along the axis of a shaft or other part. The terminology includes the words specifically noted above, derivatives thereof and words of similar import.

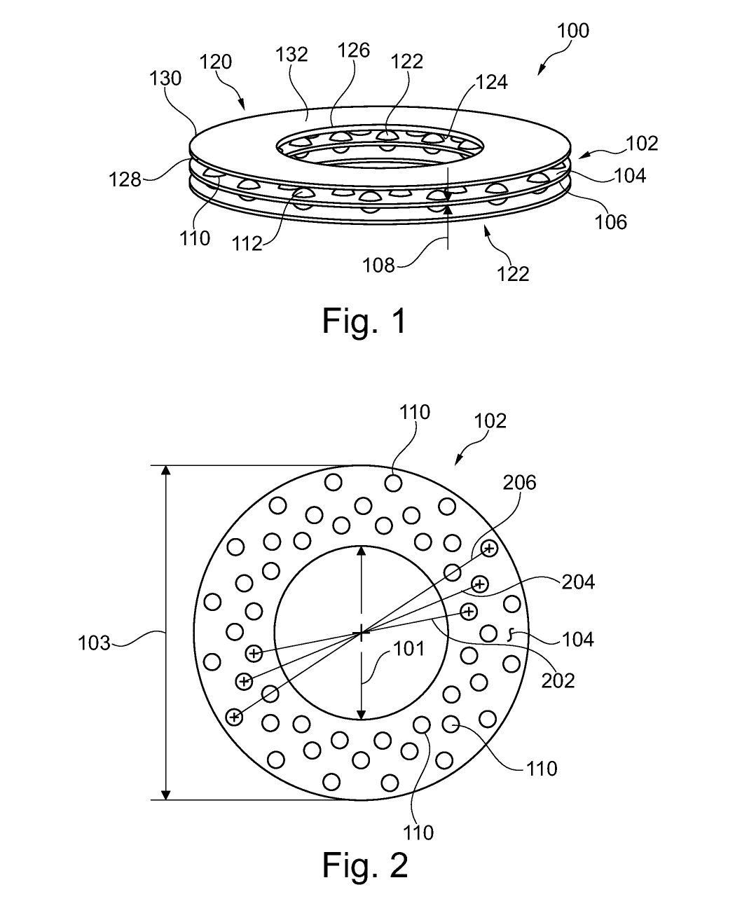

FIG. 1 illustrates an axial or thrust bearing 100 comprising a circular cage 102, shown in FIG. 2, with an inner diameter 101 and an outer diameter 103. The cage 102 has an upper cage surface 104 and a lower cage surface 106 bounding or defining a thickness 108 with pockets 110 formed through the thickness. The pockets 110 may be circular is shape as illustrated in FIGS. 1 and 2, although pockets of other shape, for example rectangular pockets, may be used with similar beneficial results as discussed below.

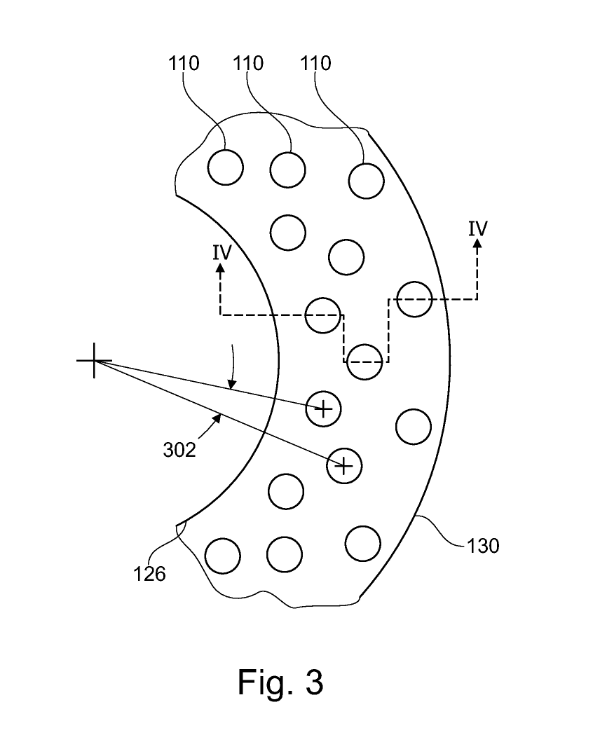

In some embodiments the pockets 110 are arranged circumferentially spaced apart on two or more pitch diameters, for example on three pitch diameters 202, 204, and 206 as illustrated in FIG. 2. In the non-limiting embodiments shown, the pockets on adjacent pitch diameters are angularly offset from each other, for example by an angle 302 as illustrated in FIG. 3. In some embodiments having more than two pitch diameters, the measured difference between adjacent pitch diameters, for example 202 and 204 and 204 and 206, may be the same, so that the radial spacing between pockets 110 on adjacent pitch diameters is the same. In other embodiments, the measured difference between adjacent pitch diameters may be different as illustrated in FIGS. 2 and 3 for example, so that the radial spacing between pockets 110 on adjacent pitch diameters is not the same. As illustrated in FIGS. 2 and 3, the radial offset between the pockets 110 on pitch diameters 202 and 204 is different than the radial offset between the pockets 110 on pitch diameters 204 and 206.

Rolling elements 112 are disposed in at least some of the pockets 110 and supported for rotation within the respective pocket. The cage 102 is illustrated with circular pockets 110 and spherical rolling elements 112 for ease of illustration only. The rolling elements 112 could also be cylindrical rolling elements and the pockets 110 rectangular in shape, or a combination of spherical and cylindrical rolling elements.

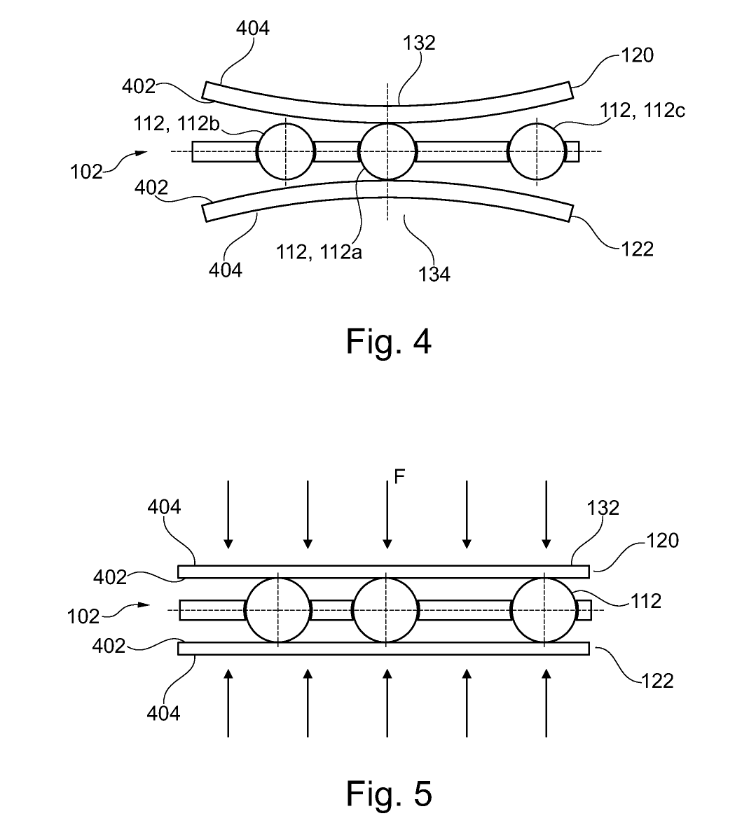

As shown in FIG. 1, an upper raceway 120 is disposed adjacent to the upper cage surface 104 and a lower raceway 122 is disposed adjacent to the lower cage surface 106. The raceways 120, 122 are similarly formed with an inner wall surface 124 defining an inner diameter 126 and an outer wall surface 128 forming an outer diameter 130. As shown in FIG. 4, an intermediate portion 132 is between the inner diameter 126 and the outer diameter 130 of the upper raceway 120. Similarly, an intermediate portion 134 is between the inner and outer diameters 126, 130 of the lower raceway 122. Each intermediate portion 132, 134 has an inward-facing surface 402 and an outward-facing surface 404 as illustrated in the embodiment of FIG. 4.

In the embodiment illustrated in FIG. 4, the intermediate portions 132, 134 of the upper raceway 120 and the lower raceway 122, respectively, are formed with convex inward-facing surfaces 402 and concave outward-facing surfaces 404. In this configuration, only a portion of the convex inward-facing surfaces 402 are in contact with a first plurality of the rolling elements 112 when the thrust bearing 100 is in a first load condition as illustrated in FIG. 4. The first load condition may correspond with a zero or nominal load.

FIG. 5 illustrates the thrust bearing 100 of FIG. 4 in a second load condition which may be a distributed load F applied to the upper and lower raceways 120 and 122. Under the load condition illustrated, the curvature of the concave/convex intermediate portions 132, 134 of the upper and lower raceways 120, 122 is reduced (i.e., the radius of curvature is increased) and the raceways are flattened out. In such a condition, the convex inward-facing surfaces 402 are in contact with a second plurality of rolling elements 112, greater than the first plurality of rolling elements in the first load condition as illustrated in FIG. 4. The second plurality may include all, or substantially all, of the rolling elements 112 of the first plurality. In some embodiments, the second plurality includes all of the rolling elements 112 disposed in the pockets 110.

In the non-limiting embodiment of FIGS. 4 and 5, the rolling elements 112 are unevenly spaced in the radial direction as discussed above. In other embodiments, the rolling elements 112 are evenly spaced in the radial direction.

FIGS. 4 and 5 illustrate two possible load conditions of the thrust bearing 100. In another load condition, not shown, an intermediate distributed load may be applied to the thrust bearing sufficient to reduce the curvature of the upper and lower raceways sufficient to place the convex inward-facing surfaces 402 in contact with a third plurality of rolling elements, greater than the first plurality but less than the second plurality. For example, the third plurality may include rolling elements 112a and 112b, whereas the first plurality comprises only rolling element 112a, and the second plurality includes rolling elements 112a, 112b, and 112c (See FIG. 4).

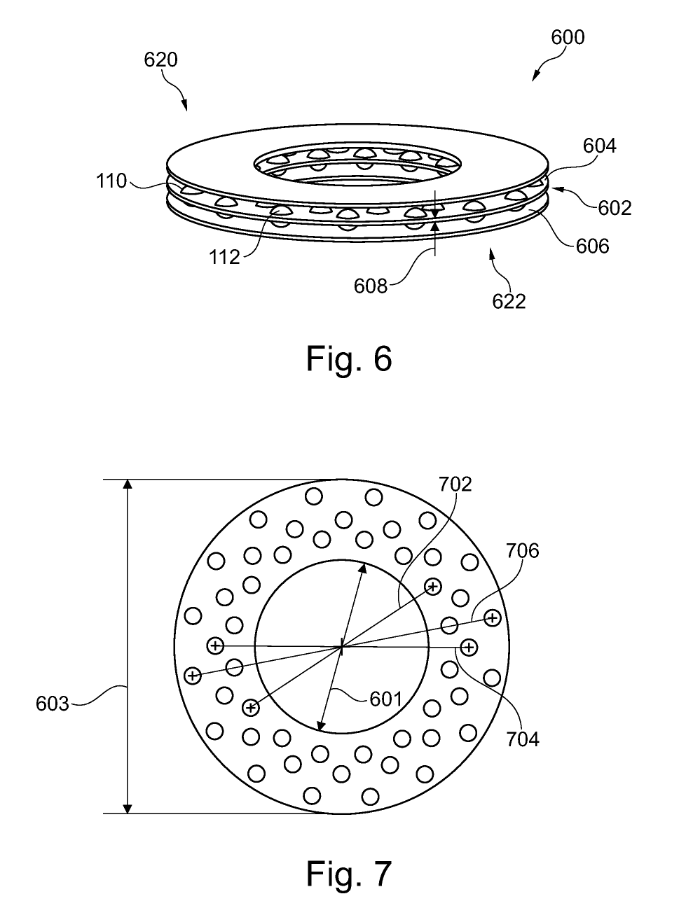

FIG. 6 illustrates an axial or thrust bearing 600 comprising a circular cage 602 with an inner diameter 601 and an outer diameter 603, shown in FIG. 7. The cage 602 has an upper cage surface 604 and a lower cage surface 606 bounding or defining a thickness 608 with pockets 610 formed through the thickness. The pockets 610 may be circular is shape as illustrated in FIGS. 6 and 7, although pockets of other shape, for example rectangular pockets, may be used with similar beneficial results as discussed below.

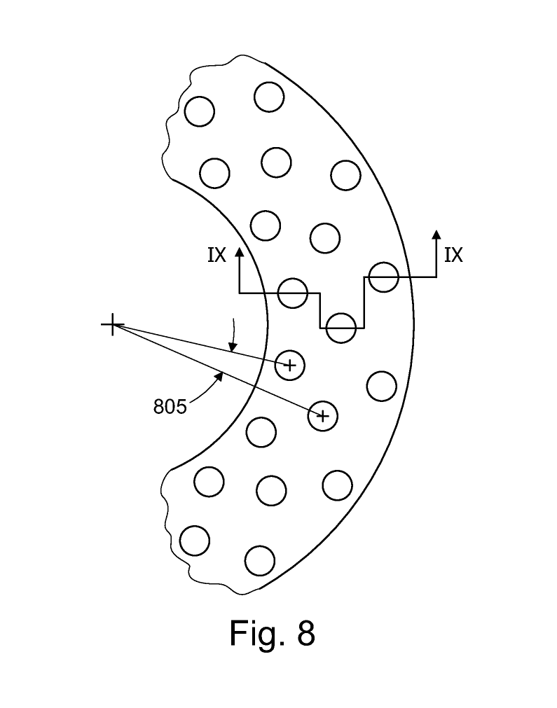

In some embodiments the pockets 610 are arranged circumferentially spaced apart on two or more pitch diameters, for example on three pitch diameters 702, 704, and 706 as illustrated in FIG. 7. In the non-limiting embodiments shown, the pockets on adjacent pitch diameters are angularly offset from each other, for example by an angle 805 as illustrated in FIG. 8. In the embodiment illustrated, the measured difference between adjacent pitch diameters, for example 702 and 704 and 704 and 706, is the same, so that the radial spacing between pockets 110 on adjacent pitch diameters is the same, although the radial spacing need not be the same.

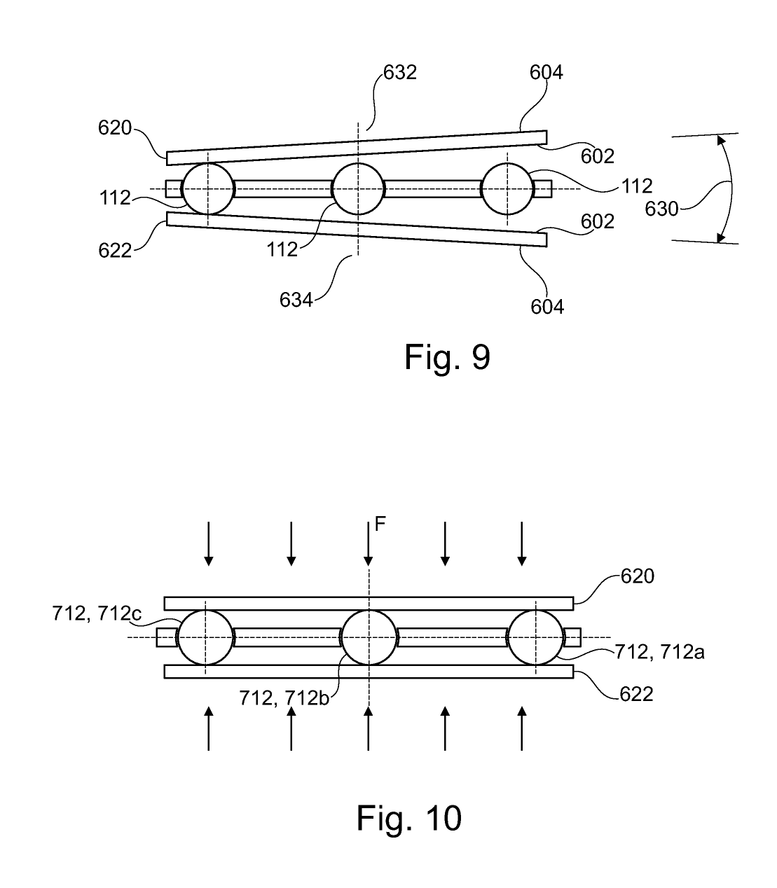

In the embodiment illustrated in FIG. 9, upper and lower raceways 620, 622 have substantially linear intermediate portions 632, 634 and inward-facing surfaces 602, with inward-facing surfaces 602 radially outwardly divergent. In this configuration, a portion of the inward-facing surfaces 602 are in contact with a first plurality of rolling elements 112 when the thrust bearing 600 is in a first load condition as illustrated in FIG. 9. The first load condition may correspond with a zero or nominal load.

FIG. 10 illustrates the thrust bearing 600 of FIG. 6 in a second load condition which may be a distributed load F applied to the upper and lower raceways 620 and 622. Under the load condition illustrated, the radially divergent inward-facing surfaces 602 of the upper raceway 620 and lower raceways 622 are urged towards each other (i.e., the angle 630 between the inward-facing surfaces 602 becomes smaller), so that the inward-facing surfaces 602 become substantially parallel. In the second load condition of FIG. 10, the inward-facing surfaces 602 are in contact with a second plurality of rolling elements 112, greater than the first plurality of rolling elements in the first load condition as illustrated in FIG. 9. The second plurality may include all, or substantially all, of the rolling elements 112 of the first plurality. In some embodiments, the second plurality may include all of the rolling elements 112 disposed in the pockets 110.

Alternately, the inward-facing surfaces 602 could be radially inwardly divergent (not shown) under a first load condition and urged towards each other under a second load condition as described above.

The illustrations of FIGS. 9 and 10 depict only two possible load conditions. In another load condition, not shown, an intermediate distributed load may be applied to the thrust bearing 600 sufficient to decrease the angle 630 between the upper and lower raceways 620, 622 so that the radially divergent inward-facing surfaces 602 are in contact with a third plurality of rolling elements, greater than the first plurality but less than the second plurality. For example as illustrated in FIG. 10, the intermediate load may decrease the angle 630 so the third plurality includes rolling elements 712b and 712c, whereas the first plurality comprises only rolling element 712c, and the second plurality includes rolling elements 712a, 712b, and 712c.

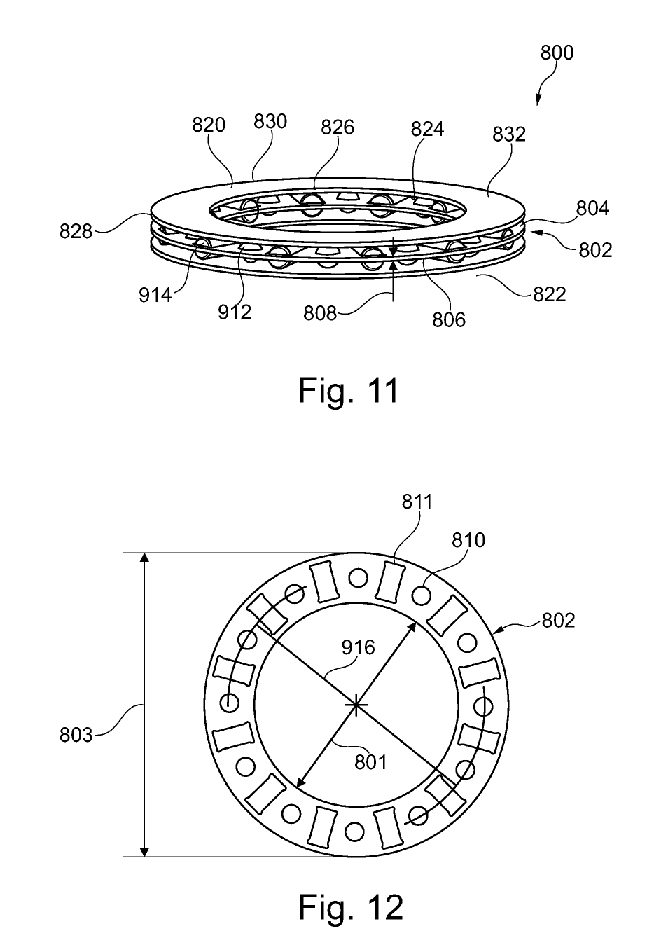

FIG. 11 is a perspective view of a thrust bearing 800 according to an embodiment of the present invention in which the rolling elements may be a combination of spherical rolling elements 912 and cylindrical rolling elements 914. Thrust bearing 800 has a circular cage 802 with an upper cage surface 804 and a lower cage surface 806 defining a thickness 808, a plurality of pockets 810, 811 formed through the thickness 808, an inner diameter 801, and outer diameter 803. The pockets 810 are generally circular and the pockets 811 are generally rectangular. Spherical rolling elements 912 are disposed in at least some of the pockets 810 and cylindrical rolling elements 914 are disposed in at least some of the pockets 811.

The cylindrical rolling elements 914 may alternate with spherical rolling elements 912 in any pattern along a pitch diameter 916. In a non-limiting embodiment illustrated in FIG. 12, one spherical rolling element 912 is disposed between adjacent cylindrical rolling elements 914. The spherical rolling elements 912 and cylindrical rolling elements 914 are preferably used with raceway configuration 120/122 described above.

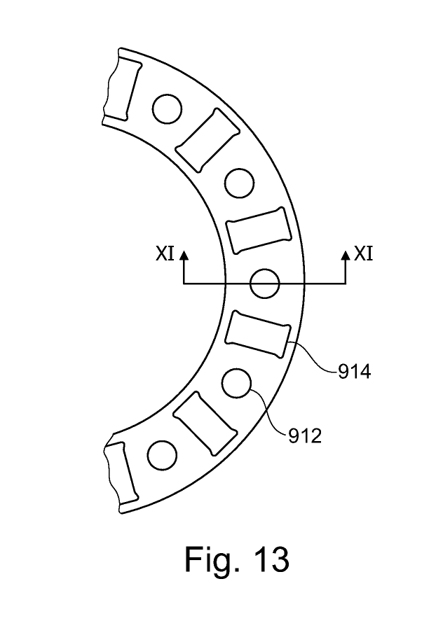

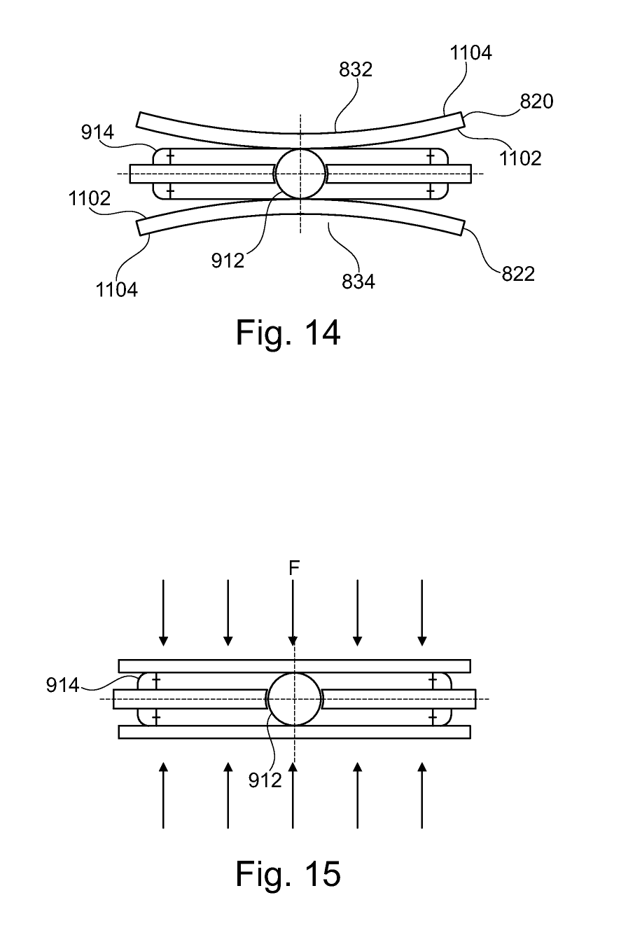

FIGS. 14 and 15 are side sectional views of a thrust bearing 800 according to FIG. 13 with upper raceway 820 and lower raceway 822 taken along line XI-XI in a first (FIG. 14) and second (FIG. 15) load condition similar to FIGS. 4 and 5. The raceways 820, 822 are similarly formed with an inner wall surface 824 defining an inner diameter 826 and an outer wall surface 828 forming an outer diameter 830 with an intermediate portion 832 between the inner diameter 826 and the outer diameter 830 of the upper raceway 820, as shown in FIG. 11. Similarly, an intermediate portion 834 is between the inner and outer diameters 826, 830 of the lower raceway 822, indicated in FIG. 14. Each intermediate portion 832, 834 has an inward-facing surface 1102 and on outward-facing surface 1104 as illustrated in FIG. 14.

The upper and lower raceways 820, 822 function as described above with regard to upper and lower raceways 120, 122, maintaining a curved configuration as in FIG. 14 under a nominal or no load condition and deflecting under a distributed load F as illustrated in FIG. 15. In the load condition of FIG. 14, a tangent of each of the inward-facing surfaces 1102 are in contact with the rolling elements 912, 914, with point contact, or essentially point contact, between the inward-facing surfaces 1102 and the cylindrical rolling element 914.

In the second load condition of FIG. 15, the distributed force F alters the curvature of the concave/convex intermediate portions 832, 834 of the upper and lower raceways 820, 822 so that the curvature is reduced (i.e., the radius of curvature is increased) and the raceways are flattened out. In such a condition, the convex inward-facing surfaces 1102 are in contact with the spherical rolling elements 912 and in line contact with the cylindrical rolling element 914. Thus, in the second load condition of FIG. 15, the contact area between the inward-facing surface 1102 and the rolling elements 912, 914 is increased over that of FIG. 14, while the number of contact points remains the same.

Thus a thrust bearing which may provide the benefit of increased load-carrying capacity with reduced overall friction over known thrust bearing constructions is provided herein. In some embodiments, the increased load-carrying capacity and reduced friction are realized by distributing increasing loads over increasing surface areas by engaging a greater number of spherical rolling elements. In some embodiments, the benefit is realized by using both spherical and cylindrical rolling elements and limiting surface contact with cylindrical rollers, known to have higher energy losses than spherical rolling elements, at low load levels. At high load levels, the surface contact with the cylindrical rollers, known to have high load-carrying capability, is increased.

Having thus described the present invention in detail, it is to be appreciated and will be apparent to those skilled in the art that many physical changes, only a few of which are exemplified in the detailed description of the invention, could be made without altering the inventive concepts and principles embodied therein. It is also to be appreciated that numerous embodiments incorporating only part of the preferred embodiment are possible which do not alter, with respect to those parts, the inventive concepts and principles embodied therein. The present embodiment and optional configurations are therefore to be considered in all respects as exemplary and/or illustrative and not restrictive, and all alternate embodiments and changes to this embodiment which come within the meaning and range of equivalency of said claims are therefore to be embraced therein.

What is claimed is:

1. A thrust bearing comprising:
a circular cage having an upper cage surface and a lower cage surface with a thickness therebetween, and pockets formed through the thickness;
rolling elements disposed in at least some of the pockets, the rolling elements having a diameter greater than the thickness;
upper and lower raceways each having inner and outer diameters and an intermediate portion between the inner and outer diameters formed with an inward-facing surface and an outward-facing surface,
wherein the inward-facing surface of the upper raceway is disposed adjacent to the upper cage surface and the inner-facing surface of the lower raceway is disposed adjacent to the lower cage surface so that a first plurality of rolling elements is in rolling contact with the upper and lower raceways when the thrust bearing is in a first load condition and a second plurality of rolling elements is in rolling contact with the upper and lower raceways when the thrust bearing is in a second load condition.

2. The bearing of claim 1, wherein the pockets are disposed on at least a first pitch diameter and a second pitch diameter.

3. The bearing of claim 2, wherein the pockets disposed on the first pitch diameter are angularly offset from the pockets disposed on the second pitch diameter.

4. The bearing of claim 1, wherein the rolling elements are spherical rolling elements.

5. The bearing of claim 1, wherein the rolling elements are cylindrical rolling elements.

6. The bearing of claim 1, wherein at least some of the rolling elements are spherical rolling elements and at least some of the rolling elements are cylindrical rolling elements.

7. The bearing of claim 1, wherein the inward-facing surfaces of the raceways are convex and the outward-facing surfaces of the raceways are concave.

8. The bearing of claim 1, wherein the inward-facing surfaces of the raceways are radially divergent.

9. The bearing of claim 1, wherein the inward-facing surfaces of the raceways are radially convergent.

10. The bearing of claim 1, wherein the second plurality includes the first plurality.

11. A thrust bearing comprising:
a circular cage having an upper cage surface and a lower cage surface with a thickness therebetween, and pockets formed through the thickness;
rolling elements disposed in at least some of the pockets, the rolling elements having a diameter greater than the thickness;
upper and lower raceways each having inner and outer diameters and an intermediate portion between the inner and outer diameters formed with an inward-facing convex surface and an outward-facing concave surface,
wherein the inward-facing surface of the upper raceway is disposed adjacent to the upper cage surface and the inward-facing surface of the lower raceway is disposed adjacent to the lower cage surface so that a first plurality of rolling elements is in rolling contact with the upper and lower raceways forming a first contact area when the thrust bearing is in a first load condition and the same plurality of rolling elements is in rolling contact with the upper and lower raceways forming a second contact area when the thrust bearing is in a second load condition.

12. The bearing of claim 10, wherein the pockets are disposed on a pitch diameter.

13. The bearing of claim 10, wherein at least some of the rolling elements are spherical rolling elements.

14. The bearing of claim 10, wherein at least some of the rolling elements are cylindrical rolling elements.
